(19) United States
(12) Patent Application Publication
(10) Pub. No.: US 2023/0296126 A1
(43) Pub. Date: Sep. 21, 2023

(54) ADHESIVE MEMBER

(71) Applicant: HONDA MOTOR CO., LTD., Tokyo (JP)

(72) Inventors: Shoko Hiraoka, Saitama (JP); Tsuyoshi Baba, Saitama (JP); Masatoshi Kobayashi, Saitama (JP); Satoshi Hirawaki, Saitama (JP)

(21) Appl. No.: 18/171,378

(22) Filed: Feb. 20, 2023

(30) Foreign Application Priority Data
Mar. 18, 2022 (JP) 2022-043875

(51) Int. Cl. F16B 43/00

(52) U.S. Cl. CPC F16B 43/001

(57) ABSTRACT

Provided is an adhesive member including a first member, a second member, and a dismantlable adhesive layer, at least parts of the first member and the second member being bonded via the dismantlable adhesive layer, in which the first member contains a resin, and includes a notch provided in a surface of the first member in contact with the dismantlable adhesive layer, the second member contains a material different from the resin, and the dismantlable adhesive layer contains a thermally expandable material.

This application is based on and claims the benefit of priority from Japanese Patent Application No. 2022-043875, filed on 18 Mar. 2022, the content of which is incorporated herein by reference.

### BACKGROUND OF THE INVENTION

### Field of the Invention

The present invention relates to an adhesive member.

### Related Art

Conventionally, when fastening and fixing a resin intake manifold to a cylinder block, a bolt is inserted into a metal collar fitted into a through hole provided in a flange part of the intake manifold (see, for example, Japanese Unexamined Patent Application, Publication No. 2014-196789).

However, when the collar is fitted into the through hole, it is difficult to separate the collar during recycling of the intake manifold. For recycling, it is necessary to coarsely crush and then pulverize the intake manifold, but since the resin is mixed with the metal, a task of removing the resin containing metal pieces occurs, before a blade becomes worn out during crushing, or pulverizing is performed. Further, in the task of removing the resin containing the metal pieces before crushing, it is necessary to remove the resin from a large amount of resin remaining around the metal, and a recovery rate of the resin decreases.

On the other hand, a dismantlable adhesive containing a thermally expandable material is known (see, for example, Japanese Unexamined Patent Application, Publication No. 2006-225544).

Patent Document 1: Japanese Unexamined Patent Application, Publication No.2014-196789

Patent Document 2: Japanese Unexamined Patent Application, Publication No.2006-225544

### SUMMARY OF THE INVENTION

Here, it is conceivable that, when attaching a collar into a through hole provided in a flange part of an intake manifold, the collar is bonded using a dismantlable adhesive. However, when a thermally expandable material is expanded during recycling of the intake manifold, compressive stress is applied from an outer peripheral surface of the collar, which may make it difficult to separate the collar.

An object of the present invention is to provide an adhesive member from which a metal member is easily separated during recycling.

According to one aspect of the present invention, an adhesive member includes a first member; a second member; and a dismantlable adhesive layer, at least parts of the first member and the second member being bonded via the dismantlable adhesive layer, the first member contains a resin, and includes a notch provided in a surface of the first member in contact with the dismantlable adhesive layer, the second member contains a material different from the resin, and the dismantlable adhesive layer contains a thermally expandable material.

The first member may be provided around the second member.

The first member may have a through hole or a non-through hole provided in the first member, the notch may be provided on an inner peripheral surface of the through hole or non-through hole, and the second member may contain a metal.

The second member may have an unevenness provided on a surface of the second member in contact with the dismantlable adhesive layer.

The notch provided in the first member may not be in contact with the unevenness provided on the second member.

The first member and the second member on one side may be bonded via the dismantlable adhesive layer, and the first member and the second member on the other side may be bonded via a non-dismantlable adhesive layer.

The thermally expandable material may be a thermally expandable microcapsule or expanded graphite.

The thermally expandable material may thermally expand at a temperature higher than a normal operating temperature of the adhesive member.

The adhesive member may be manufactured by insert molding, and the thermally expandable material may thermally expand at a temperature higher than a molding temperature in the insert molding.

The present invention can provide an adhesive member from which a metal member is easily separated even if a thermally expandable material is expanded during recycling.

### BRIEF DESCRIPTION OF THE DRAWINGS

FIGS. 1A and 1B are diagrams showing an example of an adhesive member of the present embodiment;

FIGS. 2A and 2B are diagrams showing a modification of the adhesive member of FIGS. 1A and 1B;

FIG. 3 is a diagram showing a modification of the adhesive member of FIGS. 1A and 1B;

FIG. 4 is a diagram showing a modification of the adhesive member of FIGS. 1A and 1B; and

FIGS. 5A and 5B are diagrams showing a modification of the adhesive member of FIG. 4.

### DETAILED DESCRIPTION OF THE INVENTION

Hereinafter, embodiments of the present invention will be described with reference to the drawings.

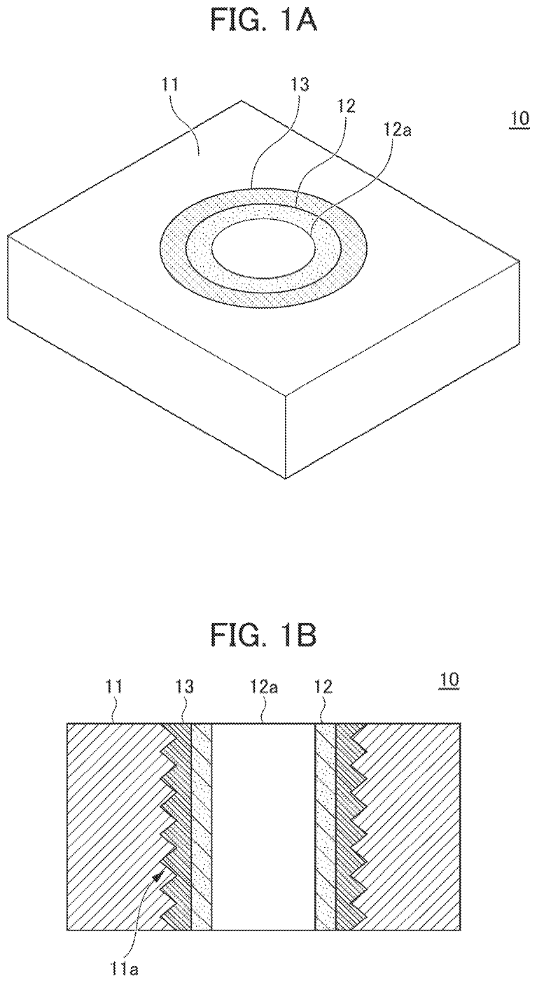

FIGS. 1A and 1B show an example of an adhesive member of the present embodiment. FIGS. 1A and 1B are a perspective view and a cross-sectional view, respectively.

An adhesive member 10 includes a first member 11 and a second member 12 that are bonded via a dismantlable adhesive layer 13. Here, the first member 11 contains a resin, and includes a plurality of notches 11a provided in a thickness direction in a surface of the first member in contact with the dismantlable adhesive layer 13. Further, the second member 12 contains a metal. The dismantlable adhesive layer 13 contains a thermally expandable material. For this reason, when the thermally expandable material is expanded during recycling of the adhesive member 10, the first member 11 breaks starting from the notches 11a, and as a result, the second member 12 is easily separated.

The first member 11 is arranged around the second member 12, that is, the notches 11a are present on an outer peripheral side of the adhesive member 10 with respect to the dismantlable adhesive layer 13, and hence the first member 11 easily breaks starting from the notches 11a.

The first member 11 may not be arranged around the second member 12, and, for example, the second member 12 may be arranged around the first member 11.

In the first member 11, a through hole is provided in a circular shape in top view, and the notches 11a are provided on an inner peripheral surface of the through hole. Thereby, when the thermally expandable material is expanded during the recycling of the adhesive member 10, compressive stress is applied from the inner peripheral surface of the through hole of the first member 11, and hence the first member 11 easily breaks starting from the notches 11a.

The number of the notches 11a provided in the thickness direction of the surface of the first member 11 in contact with the dismantlable adhesive layer 13 is not particularly limited.

The resin constituting the first member 11 is not particularly limited, and examples of the resin include polyamide 6, polyamide 66, polyamide 12, polyacrylonitrile, polystyrene, polyethylene terephthalate (PET), polybutylene terephthalate (PBT), ABS resin, polycarbonate (PC), and epoxy resin.

Specific examples of the first member 11 include an intake manifold, a bumper beam, a front bulkhead, and a resin electrical component case for an HVAC, a small motor or the like.

In the second member 12 that is cylindrical, a through hole 12a is formed in a circular shape in top view in the same manner as in the first member 11.

The metal constituting the second member 12 is not particularly limited, and examples of the metal include a copper alloy, an iron alloy, an aluminum alloy, and a magnesium alloy.

A material constituting the second member 12 is not particularly limited as long as the material is different from the resin constituting the first member 11, and the material may be, for example, a resin different from the resin constituting the first member 11, ceramic, or the like.

Specific examples of the second member 12 include a collar.

The thermally expandable material constituting the dismantlable adhesive layer 13 is not particularly limited, and examples of the material include thermally expandable particles such as thermally expandable microcapsules and expanded graphite. Examples of commercially available products of thermally expandable microcapsules include Kureha Microsphere (manufactured by KUREHA CORPORATION). Examples of commercially available products of expanded graphite include GRAFGUARD (manufactured by GrafTech International Ltd.) and TEG (manufactured by AIR WATER PERFORMANCE CHEMICAL INC.).

An expansion (foaming) start temperature of the thermally expandable material is not particularly limited, and is, for example, 160° C. or higher, and it is preferable that the thermally expandable material thermally expands at a temperature (atmospheric pressure) higher than a normal operating temperature of the adhesive member 10 (for example, −40° C. or higher and 150° C. or lower in components within an engine room, and, for example, −40° C. or higher and 100° C. or lower in components of a vehicle body system). Further, when insert molding is used as a method for manufacturing the adhesive member 10, the thermally expandable material preferably thermally expands at a temperature (atmospheric pressure) higher than a molding temperature in the insert molding (for example, 200° C. or higher and 260° C. or lower).

The thermally expandable material expands, for example, five times or more a volume at 20° C., at a temperature equal to or higher than the expansion (foaming) start temperature.

A content of the thermally expandable material in the dismantlable adhesive layer 13 is not particularly limited, and is, for example, 5% by mass or more and 50% by mass or less.

The dismantlable adhesive layer 13 may further contain a resin, fiber, and the like.

The resin is not particularly limited, and examples of the resin include thermoplastic resins such as polyamide 6, polyamide 66, polyamide 12, polyacrylonitrile, polystyrene, polyethylene terephthalate (PET), polybutylene terephthalate (PBT), ABS resin, and polycarbonate (PC), and thermosetting resins such as epoxy resin and the like.

A temperature Tg of the resin is not particularly limited, and is, for example, 150° C. or lower. Further, a dynamic elastic modulus of the resin at the expansion (foaming) start temperature of the thermally expandable material is not particularly limited, and is, for example, 20 MPa or less.

The fiber is not particularly limited, and examples of the fiber include glass fiber, carbon fiber, cellulose fiber, and aramid fiber.

A method for forming the dismantlable adhesive layer 13 is not particularly limited, and examples of the method include a method of pouring a dismantlable adhesive into a mold in which the first member 11 and the second member 12 are arranged.

The method for manufacturing the adhesive member 10 is not particularly limited, and examples of the method include a method of forming the dismantlable adhesive layer 13 on the second member 12 and then press-fitting the member with the layer into a through hole in the first member 11, and a method of forming the dismantlable adhesive layer 13 on the second member 12 and then insert-molding the first member 11.

A method for recycling the adhesive member 10 is not particularly limited, and examples of the method include a method of heating the adhesive member 10 at a temperature equal to or higher than the expansion (foaming) start temperature of the thermally expandable material and then pulverizing the first member 11. At this time, examples of a heat source include a constant temperature bath, microwaves, and induction heating.

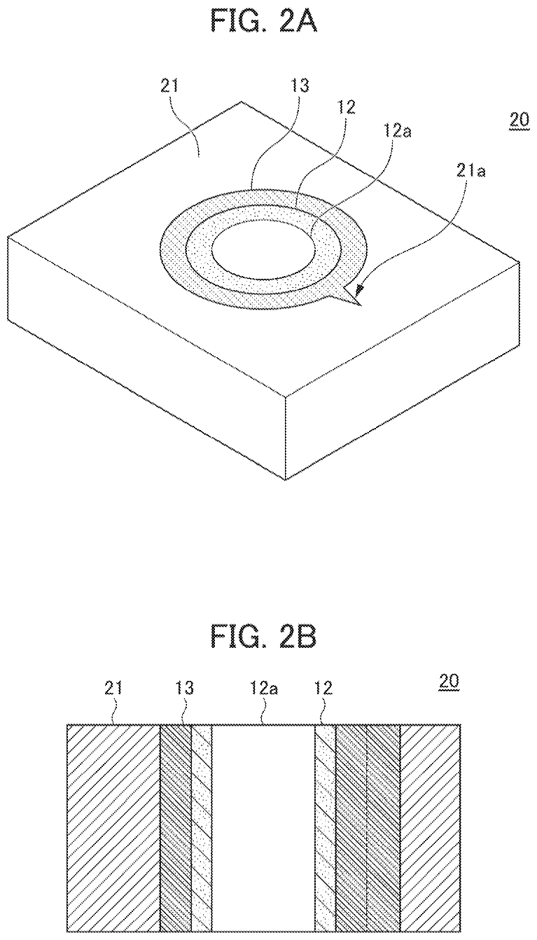

FIG. 2 shows a modification of the adhesive member 10. FIGS. 2A and 2B are a perspective view and a cross-sectional view, respectively.

An adhesive member 20 is the same as the adhesive member 10 except that a notch 21a is provided in a circumferential direction in a surface of a first member 21 in contact with a dismantlable adhesive layer 13. Also, in this case, when a thermally expandable material is expanded during recycling of the adhesive member 20, the first member 21 breaks starting from the notch 21a, and as a result, a second member 12 is easily separated.

The number of notches 21a provided in the circumferential direction in the surface of the first member 21 in contact with the dismantlable adhesive layer 13 is not particularly limited.

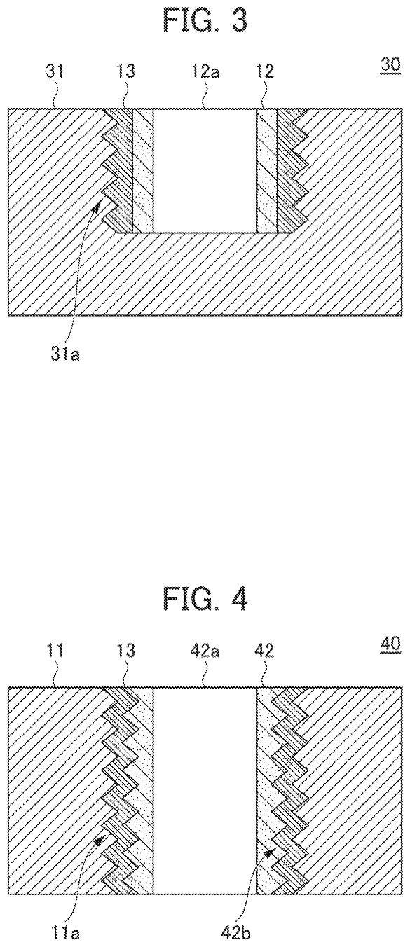

FIG. 3 shows a modification of the adhesive member 10.

An adhesive member 30 is the same as the adhesive member 10 except that a non-through hole is provided in a first member 31 and a notch 31a is provided on an inner peripheral surface of the non-through hole. Also, in this case, when a thermally expandable material is expanded during recycling of the adhesive member 30, compressive stress is applied from the inner peripheral surface of the non-through hole of the first member 31, and hence the first member 31 easily breaks starting from the notch 31a.

A cross-sectional shape of the non-through hole is not particularly limited, and examples of the shape include a circular shape.

FIG. 4 shows a modification of the adhesive member 10.

An adhesive member 40 is the same as the adhesive member 10 except that an unevenness 42b is provided on an outer peripheral surface of a second member 42. At this time, the second member 42 includes the unevenness 42b provided on a surface of the second member in contact with a dismantlable adhesive layer 13. For this reason, when a thermally expandable material is expanded during recycling of the adhesive member 40, a direction of compressive stress applied from the unevenness 42b provided on the outer peripheral surface of the second member 42 becomes complicated, and hence a first member 11 easily breaks starting from a notch 11a.

At this time, the notch 11a is not in contact with the unevenness 42b, and hence the dismantlable adhesive layer 13 is present in an entire region between the first member 11 and the second member 42, so that the first member 11 easily breaks starting from the notch 11a. Further, after the dismantlable adhesive layer 13 is dismantled, a gap is provided between the first member 11 and the second member 42, which suppresses friction by both the members, and easily separates the second member 42.

A shape of the unevenness 42b is not particularly limited, and examples of the shape include a knurling shape, a thread shape, and a wavy shape.

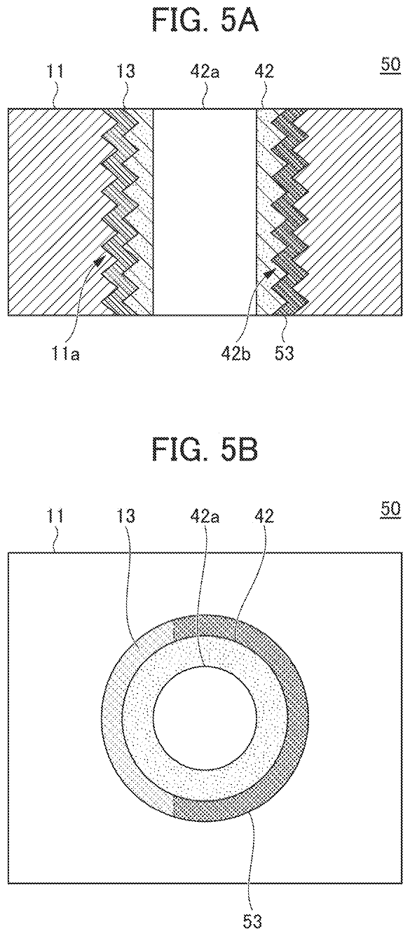

FIG. 5 shows a modification of the adhesive member 10. FIGS. 5A and 5B are a cross-sectional view and a top view, respectively.

An adhesive member 50 is the same as the adhesive member 40, except that a first member 11 and a second member 42 on one side are bonded via a dismantlable adhesive layer 13, and the first member 11 and the second member 42 on the other side are bonded via a non-dismantlable adhesive layer 53. At this time, the second member 42 has an unevenness 42b provided on a surface of the second member in contact with the dismantlable adhesive layer 13 and a surface of the second member in contact with the non-dismantlable adhesive layer 53. For this reason, when a thermally expandable material is expanded during recycling of the adhesive member 50, compressive stress is applied only from a region in contact with the dismantlable adhesive layer 13 on an inner peripheral surface of a through hole of the first member 11, and hence the first member 11 easily breaks starting from notches 11a facing the non-dismantlable adhesive layer 53.

A method for forming the non-dismantlable adhesive layer 53 is not particularly limited, and examples of the method include a method of applying a known non-dismantlable adhesive and then drying the adhesive.

At this time, it is preferable to form the dismantlable adhesive layer 13 on an inner peripheral surface of the through hole on a side where the first member 11 easily breaks. For example, when the first member 11 inside the adhesive member 50 is likely to break, the dismantlable adhesive layer 13 is provided on the inner peripheral surface of the through hole inside the adhesive member 50.

A ratio of the dismantlable adhesive layer 13 and the non-dismantlable adhesive layer 53 provided on the inner peripheral surface of the through hole in the first member 11 is not particularly limited.

Further, the notches 11a may not be provided on the surface of the first member 11 in contact with the non-dismantlable adhesive layer 53.

Although the embodiments of the present invention have been described above, the present invention is not limited to the above embodiments, and the above embodiments may be appropriately changed within the scope of the spirit of the present invention.

### EXPLANATION OF REFERENCE NUMERALS

10, 20, 30, 40, 50 adhesive member

11, 21, 31 first member

11a, 21a, 31a notch

12, 42 second member

12a, 42a through hole

13 dismantlable adhesive layer

42b unevenness

53 non-dismantlable adhesive layer

What is claimed is:

1. An adhesive member comprising a first member; a second member; and a dismantlable adhesive layer, at least parts of the first member and the second member being bonded via the dismantlable adhesive layer,
the first member containing a resin, and including a notch provided in a surface of the first member in contact with the dismantlable adhesive layer,
the second member containing a material different from the resin,
the dismantlable adhesive layer containing a thermally expandable material.

2. The adhesive member according to claim 1, wherein the first member is provided around the second member.

3. The adhesive member according to claim 1, wherein the first member has a through hole or a non-through hole provided in the first member, and the notch is provided on an inner peripheral surface of the through hole or non-through hole, and
the second member contains a metal.

4. The adhesive member according to claim 1, wherein the second member has an unevenness provided on a surface of the second member in contact with the dismantlable adhesive layer.

5. The adhesive member according to claim 4, wherein the notch provided in the first member is not in contact with the unevenness provided on the second member.

6. The adhesive member according to claim 4, wherein the first member and the second member on one side are bonded via the dismantlable adhesive layer, and
the first member and the second member on another side are bonded via a non-dismantlable adhesive layer.

7. The adhesive member according to claim 1, wherein the thermally expandable material is a thermally expandable microcapsule or expanded graphite.

8. The adhesive member according to claim 1, wherein the thermally expandable material thermally expands at a temperature higher than a normal operating temperature of the adhesive member.

9. The adhesive member according to claim 1, wherein the adhesive member is manufactured by insert molding, and
the thermally expandable material thermally expands at a temperature higher than a molding temperature in the insert molding.
